(19) United States
(12) Patent Application Publication
(10) Pub. No.: US 2024/0429657 A1
(43) Pub. Date: Dec. 26, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Hideto NAKAMURA, Mie (JP); Daisuke SAITO, Mie (JP)

(21) Appl. No.: 18/686,818

(22) PCT Filed: Aug. 18, 2022
(86) PCT No.: PCT/JP2022/031187

§ 371 Date: Feb. 26, 2024

(30) Foreign Application Priority Data
Sep. 1, 2021 (JP) 2021-142165

(51) Int. Cl. H01R 13/641; H01R 13/627

(52) U.S. Cl. CPC H01R 13/641; H01R 13/6275

(57) ABSTRACT

A connector of the present disclosure is provided with a housing connectable to a mating housing, an assembly component having a code placement surface and to be assembled with the housing at a start position and a completion position, and a code to be placed on the code placement surface. The housing includes a detection window open in a first direction and a viewing window open in a second direction different from the first direction. The code is undetectable through the detection window from the first direction by a detecting device and viewable through the viewing window from the second direction with the assembly component assembled at the start position. The code is detectable through the detection window from the first direction by the detecting device and viewable through the viewing window from the second direction with the assembly component assembled at the completion position.

### TECHNICAL FIELD

The present disclosure relates to a connector.

### BACKGROUND

Conventionally, an electrical connector described in Japanese Patent Laid-Open Publication No. 2018-535524 (Patent Document 1 below) is known as a connector provided with a connection detecting function of detecting whether or not a male housing and a female housing are properly connected. This electrical connector includes a first connector and a second connector, and the first connector is provided with a housing, a plurality of conductors held by the housing and a lever rotatably coupled to the housing. The lever is rotatable between an open position and a closed position with respect to the housing.

A barcode label is arranged on the outer surface of a left side wall of the housing. When the lever is at the open position, the barcode label is hidden by the lever and cannot be read by a barcode scanner. On the other hand, when the lever is at the closed position, the barcode label is exposed through a recessed part provided in the lever, whereby the barcode label can be read by the barcode scanner.

If the barcode label is read by the barcode scanner, it can be recorded that the first and second connectors are connected and the tracing of the progress of a manufacturing or assembling process and the like is possible.

### PRIOR ART DOCUMENT

### Patent Document

Patent Document 1: JP 2018-535524 A

### SUMMARY OF THE INVENTION

### Problems to be Solved

However, since the barcode label is hidden by the lever when the lever is at the open position in the above electrical connector, the position of the barcode label cannot be known. Therefore, depending on the position of the barcode label, it may not be possible to find the barcode label soon after the lever is rotated from the open position to the closed position.

### Means to Solve the Problem

The present disclosure is directed to a connector with a housing connectable to a mating housing, an assembly component having a code placement surface, the assembly component being assembled with the housing at a start position and a completion position, and a code to be placed on the code placement surface, the housing including a detection window open in a first direction and a viewing window open in a second direction different from the first direction, the code being undetectable through the detection window from the first direction by a detecting device and viewable through the viewing window from the second direction with the assembly component assembled at the start position, and the code being detectable through the detection window from the first direction by the detecting device and viewable through the viewing window from the second direction with the assembly component assembled at the completion position.

### Effect of the Invention

According to the present disclosure, a code can be found soon at a completion position.

### BRIEF DESCRIPTION OF THE DRAWINGS

FIG. 1 is a perspective view of a connector of a first embodiment when viewed obliquely from front.

FIG. 2 is a front view of the connector of the first embodiment.

FIG. 3 is a side view of the connector of the first embodiment.

FIG. 4 is a back view of the connector of the first embodiment.

FIG. 5 is an exploded perspective view showing constituent components of the connector of the first embodiment.

FIG. 6 is a perspective view enlargedly showing around a lock arm of the first embodiment when viewed obliquely from front.

FIG. 7 is a perspective view enlargedly showing around the lock arm of the first embodiment when viewed obliquely from behind.

FIG. 8 is a perspective view of a CPA member of the first embodiment when viewed obliquely from front.

FIG. 9 is a perspective view of the CPA member of the first embodiment when viewed obliquely from behind.

FIG. 10 is a section showing a state before the connection of a mating housing and a housing of the first embodiment is started.

FIG. 11 is a section showing a state where the connection of the mating housing and the housing of the first embodiment is completed with the CPA member located at a start position.

FIG. 12 is a section showing a state where the connection of the mating housing and the housing of the first embodiment is completed with the CPA member located at a completion position.

FIG. 13 is a vertical section showing an assembled state of the CPA member of the first embodiment.

FIG. 14 is a horizontal section showing the assembled state of the CPA member of the first embodiment.

FIG. 15 is a perspective view showing a state where the CPA member of the first embodiment is at the start position when viewed from a first direction.

FIG. 16 is a perspective view showing a state where the CPA member of the first embodiment is at the completion position when viewed from the first direction.

FIG. 17 is a perspective view of a CPA member of a second embodiment when viewed obliquely from front.

FIG. 18 is a bottom view of the CPA member of the second embodiment.

FIG. 19 is a perspective view showing a state where the CPA member of the second embodiment is at a start position when viewed from a first direction.

FIG. 20 is a perspective view showing a state where the CPA member of the second embodiment is at a completion position when viewed from the first direction.

FIG. 21 is a front view of a connector of the second embodiment.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing connectable to a mating housing, an assembly component having a code placement surface, the assembly component being assembled with the housing at a start position and a completion position, and a code to be placed on the code placement surface, the housing including a detection window open in a first direction and a viewing window open in a second direction different from the first direction, the code being undetectable through the detection window from the first direction by a detecting device and viewable through the viewing window from the second direction with the assembly component assembled at the start position, and the code being detectable through the detection window from the first direction by the detecting device and viewable through the viewing window from the second direction with the assembly component assembled at the completion position.

According to the above connector, the assembly component can be assembled with the housing at the completion position after the mating housing and the housing are connected with the assembly component assembled with the housing at the start position. The code is undetectable through the detection window from the first direction by the detecting device at the start position, but detectable through the detection window from the first direction by the detecting device at the completion position. Thus, the completion of the connection of the mating housing and the housing can be recorded in a recording device by the detecting device detecting the code and reading information.

However, since the code is undetectable by the detecting device at the start position, the code may not be found at the completion position. Accordingly, the code is viewable through the viewing window from the second direction at the start position according to the above connector. Thus, the position of the code can be grasped in advance. Therefore, the code can be reliably found also at the completion position.

(2) Preferably, the assembly component is assembled with the housing movably between the start position and the completion position, and a transition is made from a state where the code is unviewable through the detection window from the first direction to a state where the code is viewable as the assembly component is moved from the start position to the completion position.

By doing so, since the assembly component can be moved from the start position to the completion position after the assembly component is assembled with the housing at the start position, the assembly component is easily handled and workability is improved.

(3) Preferably, the assembly component is a connection assurance member, the connection assurance member being immovable from the start position to the completion position before connection of the mating housing and the housing is completed and assuring a connection completed state by being movable from the start position to the completion position after the connection of the mating housing and the housing is completed.

Since the assembly component is the connection assurance member, the connection completed state can be assured if this connection assurance member is movable from the start position to the completion position.

(4) Preferably, the code placement surface is an inclined surface inclined with respect to a connection direction of the mating housing and the housing such that the code is viewable through the detection window from the first direction and viewable through the viewing window from the second direction when the assembly component is assembled at the completion position.

Since the code placement surface is the inclined surface, the placement of the code can be optimized such that the code is viewable from both the first and second directions.

(5) Preferably, the housing includes a lock arm for locking the housing in a state connected to the mating housing, and the detection window is provided through a part of the lock arm in the first direction and the viewing window is provided through a part of the assembly component in the second direction.

Since both the lock arm and the assembly component are parts which move as the mating housing and the housing are connected, the code is more easily found at the completion position.

(6) Preferably, the code is detectable through the viewing window from the second direction by the detecting device.

By doing so, the connected state can be detected through detection results of both the detection window and the viewing window. For example, it can be detected that the assembly component is at the start position if the code is undetectable through the detection window, but is detectable through the viewing window by the detecting device. Further, it can be detected that the assembly component is at the completion position if the code is detectable through both the detection window and the viewing window by the detecting device.

(7) Preferably, the housing includes a lock arm for locking the housing in a state connected to the mating housing and a pair of protection walls disposed on both sides of the lock arm, and the detection window is provided through a part of the protection wall in the first direction and the viewing window is provided between the lock arm and the protection wall when viewed from the second direction.

Since the pair of protection walls are generally provided on the both sides of the lock arm, the detection window and the viewing window can be provided, using existing structures such as the lock arm and the protection wall.

### Details of First Embodiment of Present Disclosure

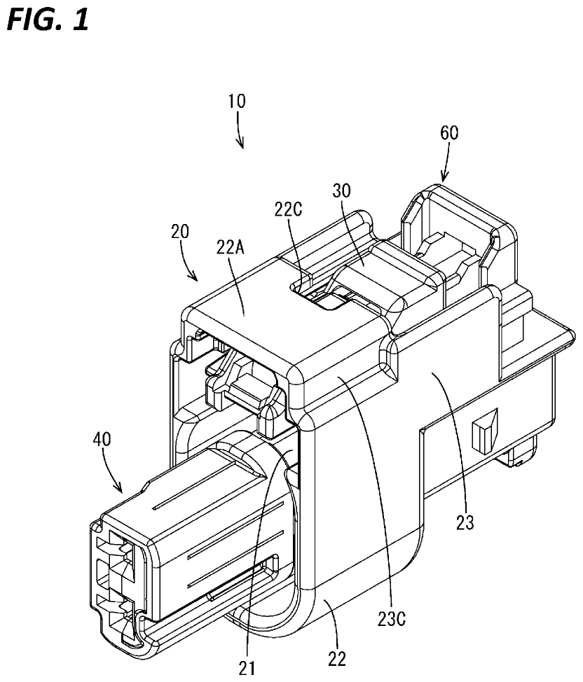

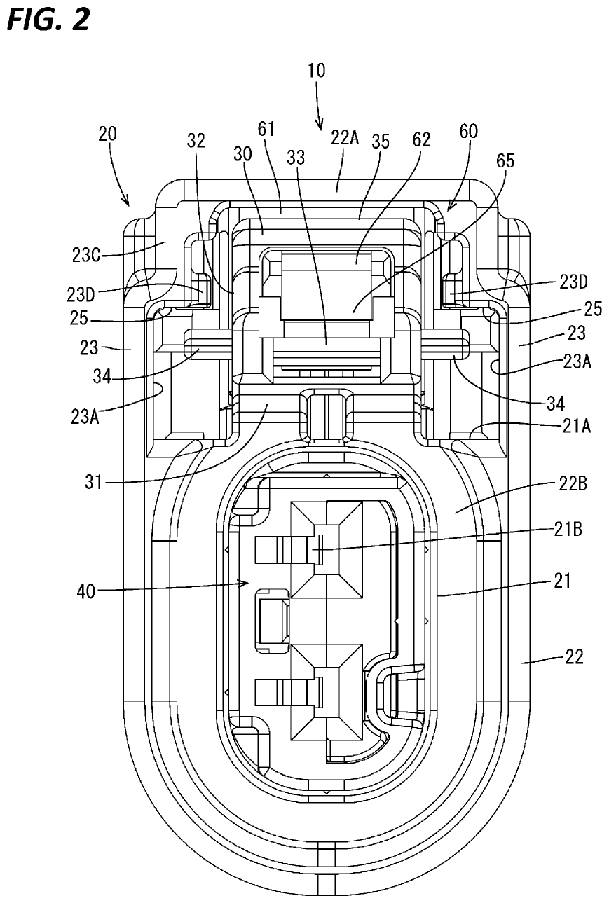

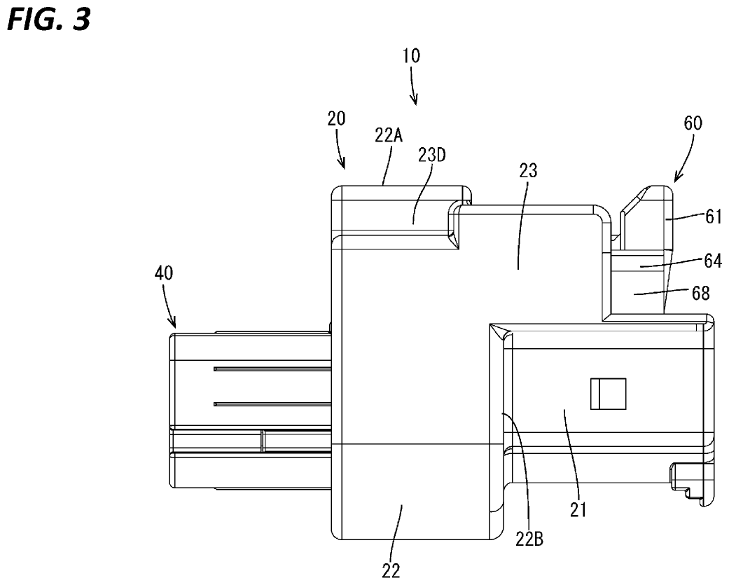

A specific example of a connector 10 of the present disclosure is described with reference to FIGS. 1 to 16. Note that the present disclosure is not limited to these illustrations, but is represented by claims and intended to include all changes in the scope of claims and in the meaning and scope of equivalents.

### Overall Structure of Connector

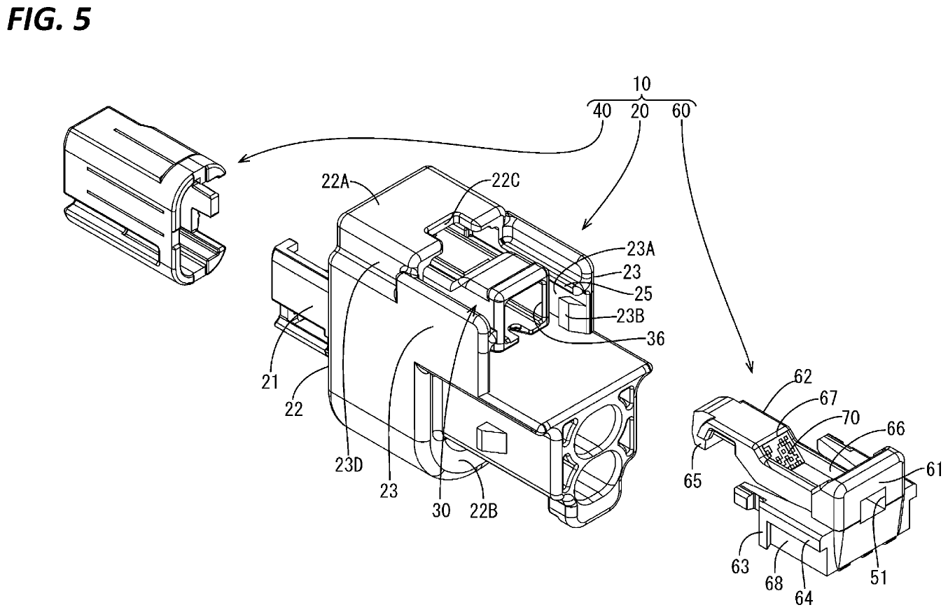

The connector 10 of a first embodiment is to be connected to a mating connector 90 and, as shown in FIG. 5, provided with a housing 20, a front holder 40 and a CPA (connector position assurance) member 60. Connection surface sides of the connector 10 and the mating connector 90 are referred to as front sides based on a connection direction of the connector 10 and the mating connector 90 concerning a front-rear direction below. Further, for a plurality of identical members, only some members may be denoted by a reference sign and the other members may not be denoted by the reference sign.

### Mating Connector

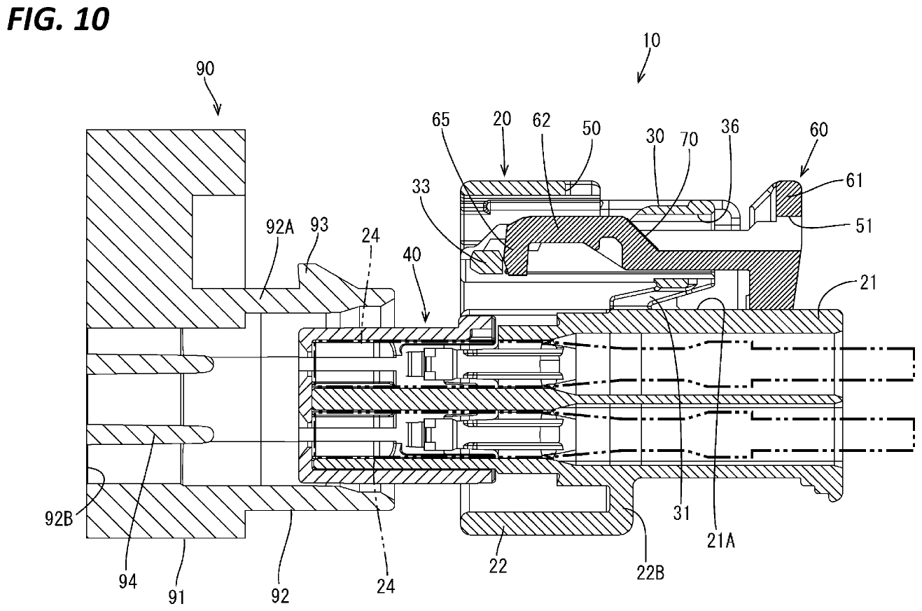

As shown in FIG. 10, the mating connector 90 is provided with a mating housing 91 including an inner receptacle 92 and male terminals 94 projecting forward from a back wall 92B of the inner receptacle 92. The mating housing 91 is made of synthetic resin. The male terminal 94 is in the form of a flat tab and made of electrically conductive metal. A lock protrusion 93 is provided to project toward an outer peripheral side on a peripheral wall 92A of the inner receptacle 92.

### Housing

The housing 20 is made of synthetic resin and, as shown in FIG. 10, provided with a terminal accommodating portion 21 for accommodating female terminals 24 inside, an outer receptacle 22 provided on an outer peripheral side of the terminal accommodating portion 21, a lock arm 30 provided on an upper surface 21A of the terminal accommodating portion 21 and a pair of protection walls 23 provided on both sides of the lock arm 30.

As shown in FIG. 1, a front end side of the outer receptacle 22 is formed to bulge upward, and a front end side of the lock arm 30 is accommodated inside this bulging portion 22A. Side wall parts on both sides of the bulging portion 22A are constituted by front halves of the protection walls 23. Therefore, rear halves of the protection walls 23 are connected to the rear end of the bulging portion 22A.

The terminal accommodating portion 21 is provided through a back wall 22B of the outer receptacle 22 in the front-rear direction. The front holder 40 is attached to a part projecting further forward than the outer receptacle 22, out of the terminal accommodating portion 21. With the front holder 40 attached to the terminal accommodating portion 21, the female terminals 24 are stopped in front by the front wall of the front holder 40. Locking lances 21B for preventing the female terminals 24 from coming out rearward are provided in the terminal accommodating portion 21.

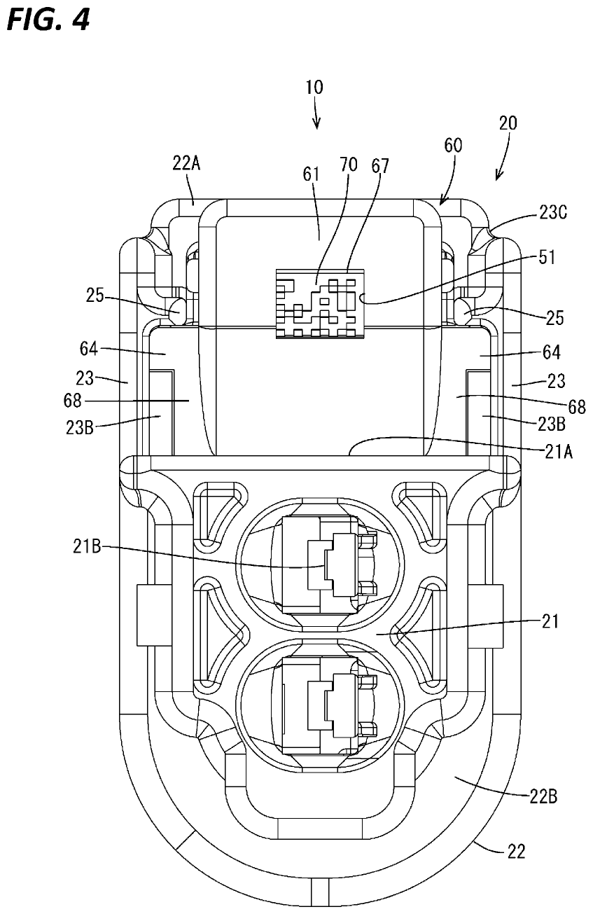

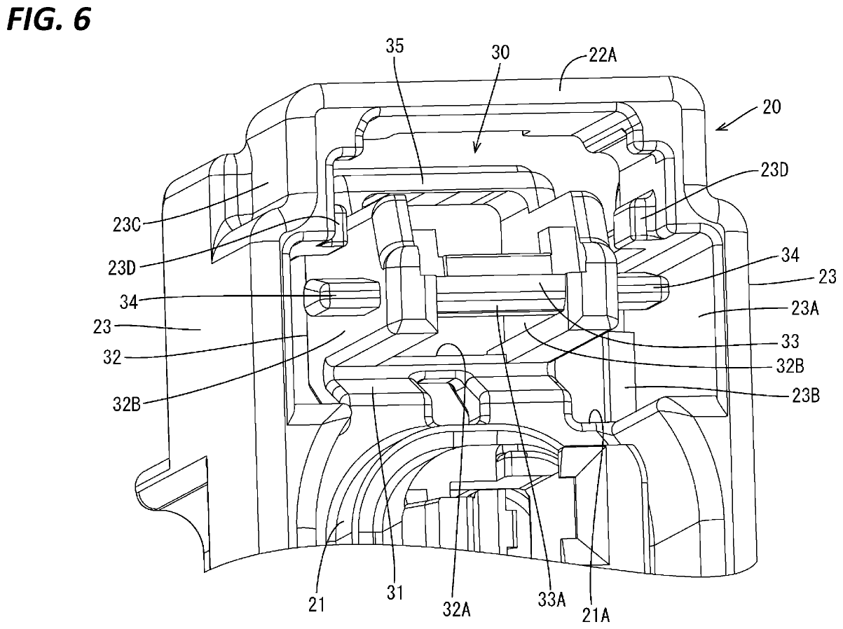

As shown in FIGS. 4 and 6, a pair of holding protrusions 23B are provided on facing surfaces 23A facing each other, out of the pair of protection walls 23. The holding protrusions 23B are protrusions for retaining the CPA member 60 as described later, and provided on rear end parts of the protection walls 23. Out of the pair of protection walls 23, upper sides of parts constituting the bulging portion 22A serve as narrow portions 23C formed to be narrower than lower sides. Surfaces of these narrow portions 23C facing each other are provided with a pair of excessive deformation restricting protrusions 23D.

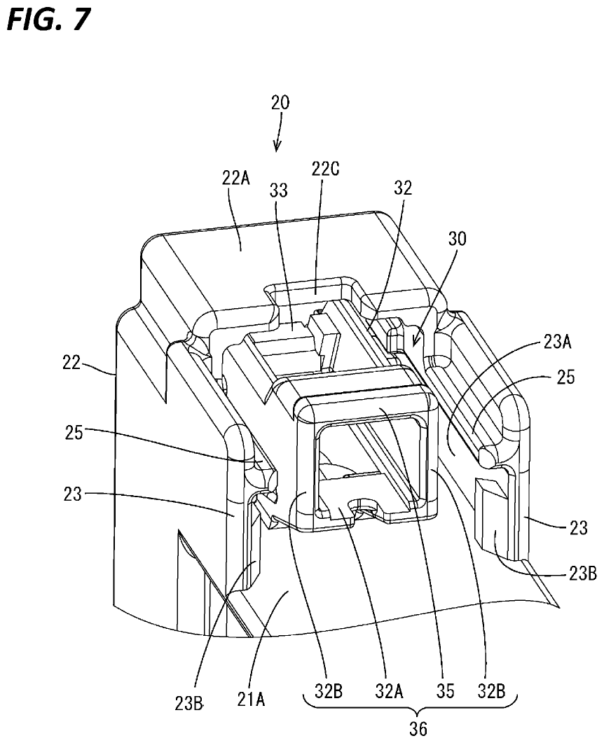

As shown in FIGS. 6 and 7, a pair of side ribs 25 for assembling the CPA member 60 with the housing 20 are provided on the rear ends of the narrow portions 23C. The lower surfaces of the narrow portions 23C and those of the pair of side ribs 25 constitute the same planes. A space between the lower surfaces of the side ribs 25 and the upper surface 21A of the terminal accommodating portion 21 serves as a space for assembling the CPA member 60. Note that the lower surfaces of the excessive deformation restricting protrusions 23D and those of the narrow portions 23C constitute the same planes.

### Lock Arm

As shown in FIG. 6, the lock arm 30 includes a lock base portion 31 extending from the upper surface 21A of the terminal accommodating portion 21 and a lock body 32 connected to the lock base portion 31 and extending forward in parallel to the upper surface 21A of the terminal accommodating portion 21. The lock base portion 31 is constituted by a pair of flexible pieces. The lock base portion 31 is deflected and deformed, whereby the front end of the lock body 32 can be swingably displaced like a seesaw.

As shown in FIG. 7, the lock body 32 includes a bottom wall 32A coupled to the lock base portion 31 and a pair of side walls 32B rising upward from both side edges of the bottom wall 32A while being arranged to face each other. The side walls 32B project further forward than the front edge of the bottom wall 32A. The front ends of the side walls 32B are arranged at positions to be covered by the bulging portion 22A. That is, the lock body 32 is in the form of a cantilever extending with a coupled part to the lock base portion 31 as a base end.

As shown in FIG. 6, a locking portion 33 is provided on a front end part of the lock body 32. The locking portion 33 is provided to extend between the pair of side walls 32B. The locking portion 33 is in the form of a block and extend to both sides. One extending end part of the locking portion 33 is coupled to one side wall 32B, and the other extending end part of the locking portion 33 is coupled to the other side wall 32B.

A tapered surface 33A is provided on a lower part of the front end of the locking portion 33. The tapered surface 33A rides on the lock protrusion 93 in connecting the connector 10 and the mating connector 90. In this way, the locking portion 33 is locked to the lock protrusion 93 at the same time as riding over the lock protrusion 93, whereby the both connectors 10, 90 are locked in a connected state.

As shown in FIG. 6, a pair of excessive deformation restricting pieces 34 are provided to project laterally at positions corresponding to the locking portion 33 on the pair of side walls 32B. The excessive deformation restricting piece 34 is provided on a surface opposite to the locking portion 33, out of both side surfaces of the side wall 32B. The pair of excessive deformation restricting pieces 34 restrict excessive deflection to protect the lock arm 30 by coming into contact with the pair of excessive deformation restricting protrusions 23D when the lock arm 30 is about to be excessively deflected and deformed.

As shown in FIG. 7, an operating portion 35 is provided on a rear end part of the lock body 32. The operating portion 35 is provided to extend between the pair of side walls 32B. The operating portion 35 is in the form of a flat plate and extends to both sides. One extending end part of the operating portion 35 is coupled to the one side wall 32B, and the other extending end part of the operating portion 35 is coupled to the other side wall 32B.

The operating portion 35 is disposed to couple the upper edges of the pair of side walls 32B and be parallel to the bottom wall 32A. In this way, a CPA introducing portion 36 in the form of a rectangular tube by the bottom wall 32A, the pair of side walls 32B and the operating portion 35 is provided in a rear end part of the lock body 32.

### CPA Member

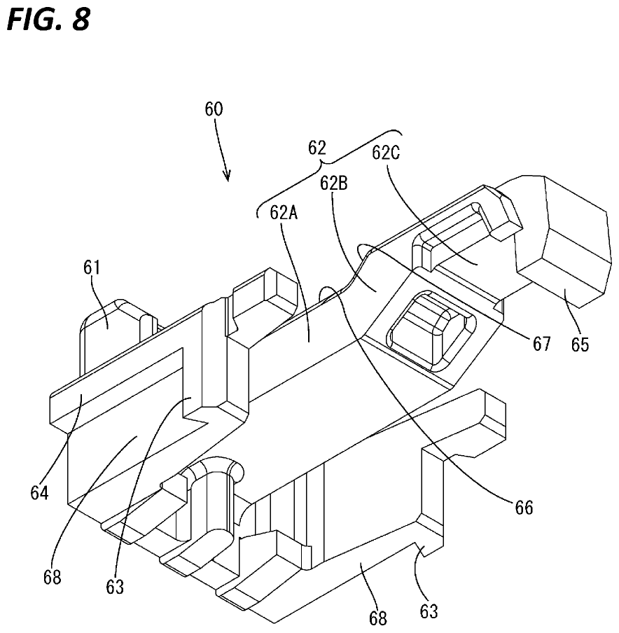

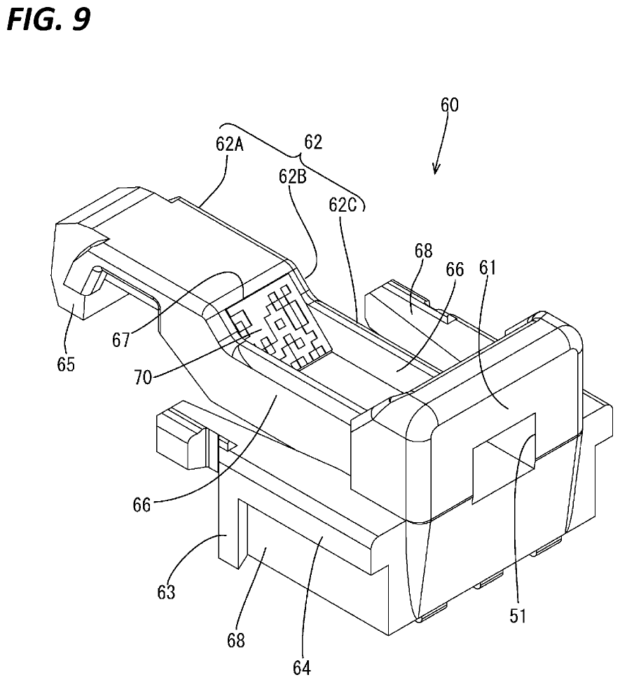

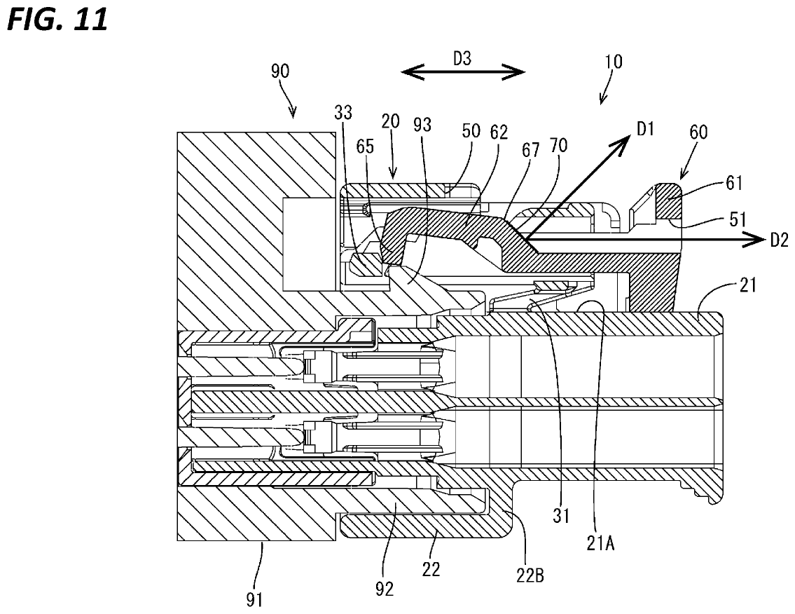

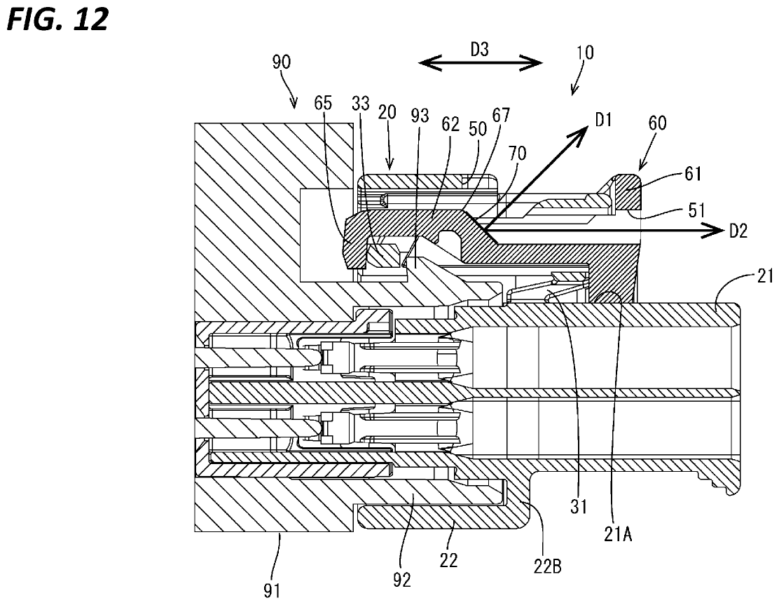

The CPA member 60 is made of synthetic resin and includes, as shown in FIGS. 8 and 9, a push-in portion 61, a CPA body 62 extending from a center of the push-in portion 61 and a pair of arms 68 extending respectively from both sides of the push-in portion 61. The CPA member 60 is movable in the front-rear direction between a start position shown in FIG. 11 and a completion position shown in FIG. 12. Any of the CPA body 62 and the pair of arms 68 is in the form of a cantilever extending forward.

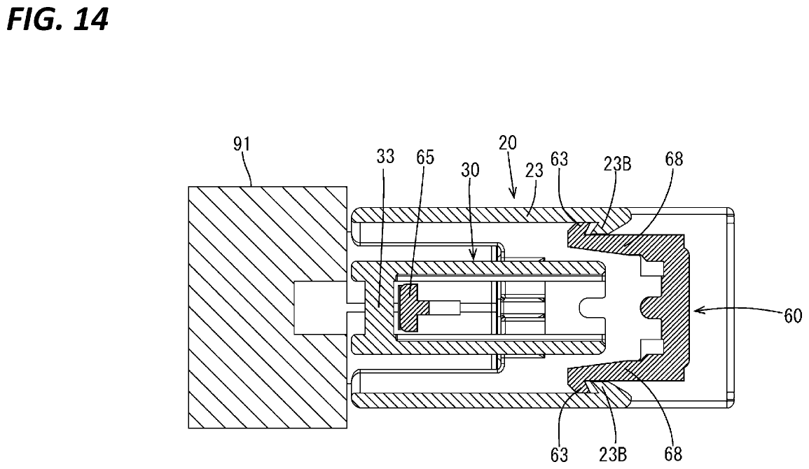

As shown in FIG. 8, a locking protrusion 63 is provided to project laterally on a side surface of the arm 68 opposite to the CPA body 62. The locking protrusion 63 extends in a vertical direction along the front edge of the arm 68, and provided on each of the pair of arms 63. As shown in FIG. 14, a pair of the locking protrusions 63 are locked to the pair of holding protrusions 23B to hold the housing 20 with the CPA member 60 retained when the CPA member 60 is assembled with the housing 20. The pair of arms 68 are deflected and deformed inwardly when the CPA member 60 is assembled with the housing 20. In this way, the pair of locking protrusions 63 are locked to the pair of holding protrusions 23B at the same time as riding over the pair of holding protrusions 23B, whereby the CPA member 60 is held on the housing 20 and prevented from being detached rearward.

As shown in FIG. 9, the guide rib 64 is provided to project laterally on the side surface of the arm 68 where the locking protrusion 63 is provided. The guide rib 64 is provided on each of the pair of arms 68 while extending in the front-rear direction along the upper edge of the arm 68. The front end of the guide rib 64 and the upper end of the locking protrusion 63 are coupled, and the guide rib 64 and the locking protrusion 63 are arranged in an L shape as a whole.

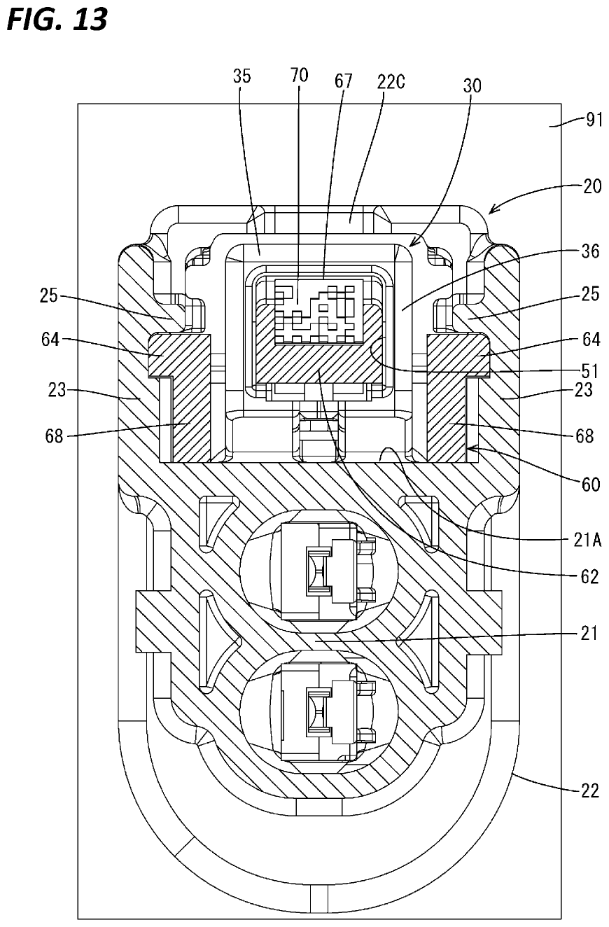

As shown in FIG. 13, the upper surface of the guide rib 64 and that of the arm 68 constitute the same plane. The upper surface of the guide rib 64 is in contact with the lower surface of the side rib 25, and the lower surface of the arm 68 is in contact with the upper surface 21A of the terminal accommodating portion 21. Further, the side surface of the guide rib 64 is in contact with the facing surface 23A of the protection wall 23. Furthermore, the CPA body 62 is accommodated into the CPA introducing portion 36 and both side surfaces of the CPA body 62 are in contact with both side walls of the CPA introducing portion 36. In this way, in assembling the CPA member 60 with the housing 20, the arms 68 are accommodated between the guide ribs 64 and the terminal accommodating portion 21, whereby movements thereof in the vertical direction and lateral direction are restricted and movements thereof in the front-rear direction are guided.

As shown in FIG. 9, the CPA body 62 includes a CPA base end part 62A extending forward from the push-in portion 61, a CPA intermediate part 62B extending obliquely to an upper front side from the front end of the CPA base end part 62A and a CPA tip part 62C extending forward from the front end of the CPA intermediate part 62B. A restricting projection 65 is provided to project downward on the front end of the CPA tip part 62C.

An operation of assembling the CPA member 60 with the housing 20 is performed by inserting the CPA body 62 into the CPA introducing portion 36 of the housing 20 from behind and inserting the pair of arms 68 between the pair of side ribs 25 and the terminal accommodating portion 21 from behind. An inserting operation is stopped by the restricting projection 65 coming into contact with the locking portion 33 from behind, and the pair of locking protrusions 63 are locked to the pair of holding protrusions 23B, whereby the CPA member 60 is prevented from being detached rearward. In this way, the CPA member 60 is held at the start position.

As shown in FIG. 10, since the restricting projection 65 is in contact with the locking portion 33 from behind in a state before the connection of the connector 10 and the mating connector 90 is started, a movement of the CPA member 60 from the start position to the completion position is restricted.

On the other hand, with the connection of the connector 10 and the mating connector 90 completed, the restricting projection 65 rides on the lock protrusion 93 and the CPA body 62 is inclined, thereby allowing the CPA member 60 to move from the start position to the completion position. At the same time as the restricting projection 65 rides over the locking portion 33, the CPA body 62 returns to a horizontal posture from an inclined posture. That is, the CPA member 60 is a connection assurance member which is immovable from the start position to the completion position before the connection of the mating housing 91 and the housing 20 is completed and assures a connection completed state by being movable from the start position to the completion position after the connection of the mating housing 91 and the housing 20 is completed.

A pair of reinforcing walls 66 are provided to project upward on both side edges of the CPA base end part 62A. The front edges of the reinforcing walls 66 are coupled to the CPA intermediate part 62B, and the rear edges of the reinforcing walls 66 are coupled to the push-in portion 61. The CPA base end part 62A is reinforced by the pair of reinforcing walls 66.

### Code Placement Surface

The CPA intermediate part 62B has a code placement surface 67. A code 70 is placed on the code placement surface 67. The front edges of the pair of reinforcing walls 66 are coupled to both sides of the code 70 on the code placement surface 67. The code placement surface 67 is a flat surface and an inclined surface inclined at an angle of 45° with respect to the front-rear direction, which is the connection direction (direction denoted by D3 in FIGS. 11 and 12) of the connector 10 and the mating connector 90. Thus, the code 70 placed on the code placement surface 67 also has a planar shape and is inclined at an angle of 45° with respect to the front-rear direction.

### Code

Any one of a one-dimensional code, a two-dimensional code and a three-dimensional code may be used as the code 70, but a two-dimensional code is used in the first embodiment. Further, the code 70 of the first embodiment is printed by applying laser processing to the code placement surface 67, but a plate-like code formed separately from the code placement surface 67 may be adhered to the code placement surface 67.

Information such as “connection completion” and “lot number” is recorded as a two-dimensional code in the code 70. This code 70 can be read using a detecting device such as a reader, and the read information can be recorded in a recording device. For example, after the connector 10 and the mating connector 90 are connected, the reader detects the code 70 and reads the information, whereby the completion of the connection of the connector 10 and the mating connector 90 can be recorded in the recording device.

As a prerequisite of such a usage, it is thought to hide the code 70 so that the reader cannot detect the code 70 before the connection of the connector 10 and the mating connector 90 is completed. However, since if the code 70 is hidden, an operator cannot grasp the position of the code 70 in advance. Thus, the code 70 may not be found in detecting the code 70 by the reader.

Accordingly, by providing a viewing window 51 separately from a detection window 50 for detecting the code 70 by the reader in the first embodiment, the operator can grasp the position of the code 70 in advance by viewing the code 70 through the viewing window 51. In the first embodiment, the detection window 50 is provided through a part of the lock arm 30 in a first direction (direction denoted by D1 in FIGS. 11 and 12), and the viewing window 51 is provided through a part of the CPA member 60 in a second direction (direction denoted by D2 in FIGS. 11 and 12).

### Detection Window

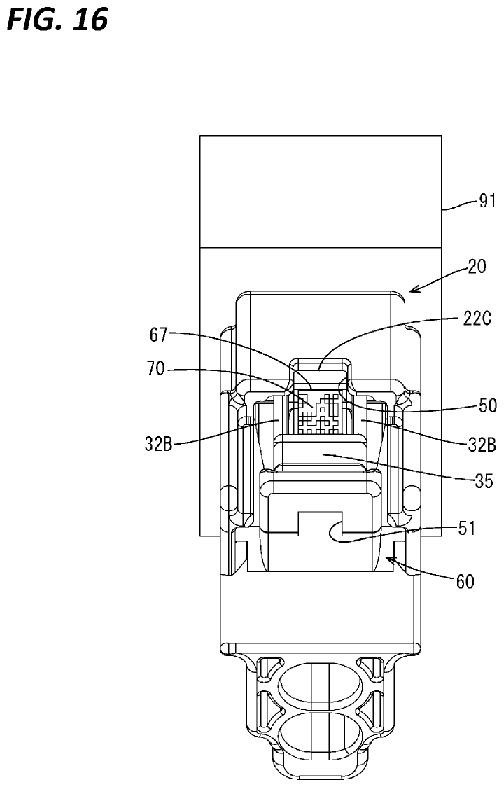

As shown in FIG. 16, the detection window 50 is a region surrounded by a recess 22C provided in the rear end of the bulging portion 22A, the pair of side walls 32B of the lock body 32 and the front edge of the operating portion 35. Since the code 70 is exposed to outside through the detection window 50 with the CPA member 60 assembled at the completion position, the reader can detect the code 70. A direction orthogonal to the plane of FIG. 16 corresponds to the first direction described above. On the other hand, since the code 70 is arranged behind the detection window 50 and hidden by the operating portion 35 with the CPA member 60 assembled at the start position, the reader cannot detect the code 70. That is, as the CPA member 60 moves from the start position to the completion position, the code 70 transitions from a state where the code 70 is unviewable through the detection window 50 from the first direction to a state where the code 70 is viewable.

### Viewing Window

As shown in FIG. 4, the viewing window 51 is provided through the push-in portion 61 of the CPA member 60 in the front-rear direction. FIG. 4 is a back view showing the state where the CPA member 60 is assembled at the start position. Since a back view showing the state where the CPA member 60 is assembled at the completion position is the same as FIG. 4, this back view is omitted. Regardless of at which of the start position and the completion position the CPA member 60 is assembled, the operator can view the code 70 through the viewing window 51. A direction orthogonal to the plane of FIG. 4 corresponds to the second direction described above. Note that, in the first embodiment, the reader can detect the code 70 through the viewing window 51, regardless of at which of the start position and the completion position the CPA member 60 is assembled.

### Connection of Housing and Mating Housing

In a state where the housing 20 is not connected to the mating housing 91, the CPA member 60 is held at the start position as shown in FIG. 10. In connecting the housing 20 to the mating housing 91, a connecting operation is performed by fitting the terminal accommodating portion 21 into the inner receptacle 92 of the mating housing 91 and fitting the inner receptacle 92 into the outer receptacle 22 of the housing 20.

If the locking portion 33 of the lock arm 30 approaches the position of the lock protrusion 92 of the mating housing 91 during the connecting operation, the lock base portion 31 is resiliently deformed, whereby the locking portion 33 rides on the lock protrusion 93 and the lock body 32 takes an inclined posture. When the connecting operation is continued and the connection is completed, the lock base portion 31 is resiliently restored at the same time as the locking portion 33 rides over the lock protrusion 93, whereby the lock body 32 takes a horizontal posture and the locking portion 33 is locked to the lock protrusion 93. In this way, the housing 20 and the mating housing 91 are held in the connection completed state, the CPA body 62 takes an inclined posture and the restricting projection 65 rides on the lock protrusion 93.

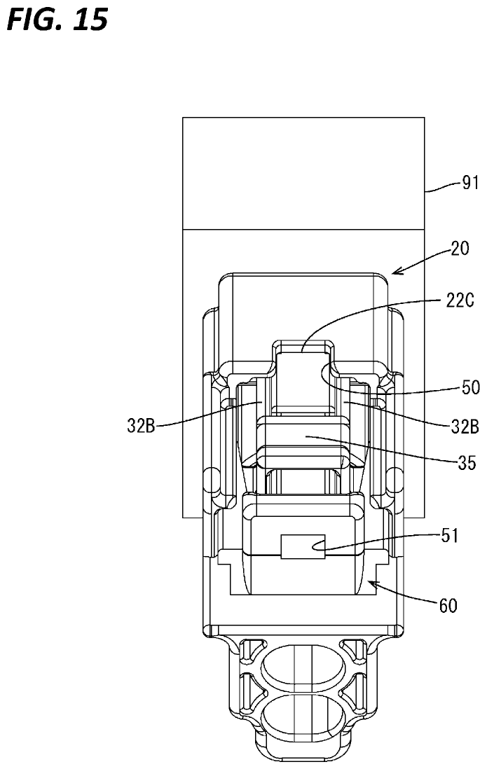

When the CPA member 60 is at the start position, the code 70 is not exposed to outside through the detection window 50 as shown in FIG. 15. Thus, the reader cannot read the code 70 through the detection window 50. On the other hand, since the operator can view the code 70 through the viewing window 51 as shown in FIG. 4, the operator can grasp the position of the code 70 and predict the position of the coded 70 after a movement of the CPA member 60 to the completion position. Further, the operator can also confirm the position of the detection window 50 based on the predicted position of the code 70.

Subsequently, the CPA member 60 is moved from the start position to the completion position by pushing the push-in portion 61 of the CPA member 60 with fingers. During a push-in operation, a transition is made from a state where the restricting projection 65 of the CPA body 62 is on the lock protrusion 93 to a state where the restricting projection 65 is on the locking portion 33. When the CPA member 60 reaches the completion position, the CPA body 62 returns to the horizontal posture and the restricting projection 65 is arranged in front of the locking portion 33 at the same time as the restricting projection 65 rides over the locking portion 33. The restricting projection 65 is locked to the locking portion 33 from front, whereby a movement of the CPA member 60 from the completion position to the start position is restricted.

When the CPA member 60 is at the completion position, the code 70 is exposed to outside through the detection window 50 as shown in FIG. 16. Here, the operator can quickly find out the code 70 based on information on the predicted position of the code 70 and the position of the detection window 50 obtained at the start position. Therefore, the code 70 is read through the detection window 50 by the reader, the information such as the “connection completion” and the “lot number” is read out by the reader, and these pieces of information are recorded in the recording device.

### Functions and Effects of First Embodiment

The connector 10 of the present disclosure is provided with the housing 20 connectable to the mating housing 91, the CPA member 60 having the code placement surface 67 and to be assembled with the housing 20 at the start position and the completion position and the code 70 to be placed on the code placement surface 67. The housing 20 includes the detection window 50 open in the first direction DI and the viewing window 51 open in the second direction D2 different from the first direction D1. With the CPA member 60 assembled at the start position, the code 70 is undetectable through the detection window 50 from the first direction D1 by the detecting device and the code 70 is viewable through the viewing window 51 from the second direction D2. With the CPA member 60 assembled at the completion position, the code 70 is detectable through the detection window 50 from the first direction D1 by the detecting device and the code 70 is viewable through the viewing window 51 from the second direction D2.

According to the above connector 10, after the mating housing 91 and the housing 20 are connected with the CPA member 60 assembled with the housing 20 at the start position, the CPA member 60 can be assembled with the housing 20 at the completion position. Although the code 70 is undetectable through the detection window 50 from the first direction D1 by the reader at the start position, the code 70 is detectable through the detection window 50 from the first direction D1 by the detecting device at the completion position. Thus, the completion of the connection of the mating housing 91 and the housing 20 can be recorded in the recording device by the detecting device detecting the code 70 and reading the information.

However, since the code 70 is undetectable by the detecting device at the start position, the code 70 may not be found at the completion position. Accordingly, the code 70 is made viewable through the viewing window 51 from the second direction D2 at the start position according to the above connector 10. Thus, the position of the code 70 can be grasped in advance. Therefore, the code 70 can be reliably found also at the completion position.

Preferably, the CPA member 60 is assembled with the housing 20 movably between the start position and the completion position, and a transition is made from the state where the code 70 is unviewable through the detection window 50 from the first direction D1 to the state where the code 70 is viewable as the CPA member 60 is moved from the start position to the completion position.

By doing so, the CPA member 60 can be moved from the start position to the completion position after the CPA member 60 is assembled with the housing 20 at the start position. Thus, the CPA member 60 is easily handled and workability is improved.

Preferably, the CPA member 60 is a connection assurance member which is immovable from the start position to the completion position before the connection of the mating housing 91 and the housing 20 is completed and assures the connection completed state by being movable from the start position to the completion position after the connection of the mating housing 91 and the housing 20 is completed.

Since the CPA member 60 is the connection assurance member, the connection completed state can be assured if this connection assurance member is movable from the start position to the completion position.

Preferably, the code placement surface 67 is formed into an inclined surface inclined with respect to the connection direction of the mating housing 91 and the housing 20 such that the code 70 is viewable through the detection window 50 from the first direction D1 and through the viewing window 51 from the second direction D2 when the CPA member 60 is assembled at the completion position.

Since the code placement surface 67 is formed into the inclined surface, the placement of the code 70 can be optimized such that the code 70 is viewable from both the first direction D1 and the second direction D2.

Preferably, the housing 20 includes the lock arm 30 for locking the housing 20 in the state connected to the mating housing 91, the detection window 50 is provided through a part of the lock arm 30 in the first direction D1 and the viewing window 51 is provided through a part of the CPA member 60 in the second direction D2.

Since both the lock arm 30 and the CPA member 60 are parts which move as the mating housing 91 and the housing 20 are connected, the code 70 is more easily found at the completion position.

Preferably, the code 70 is detectable through the viewing window 51 from the second direction D2 by the reader.

By doing so, the connected state can be detected through detection results of both the detection window 50 and the viewing window 51. For example, it can be detected that the CPA member 60 is at the start position if the code 70 is undetectable through the detection window 50 by the reader and detectable through the viewing window 51. Further, it can be detected that the CPA member 60 is at the completion position if the code 70 is detectable through both the detection window 50 and the viewing window 51 by the reader.

### Details of Second Embodiment of Present Disclosure

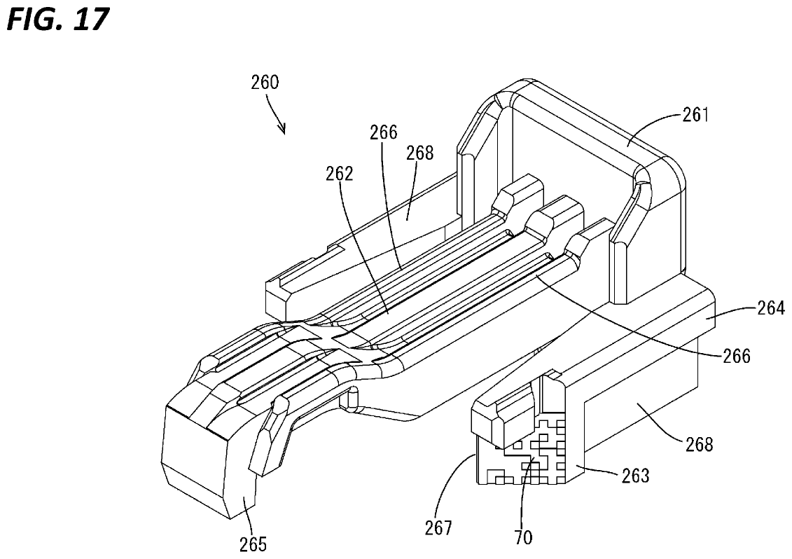

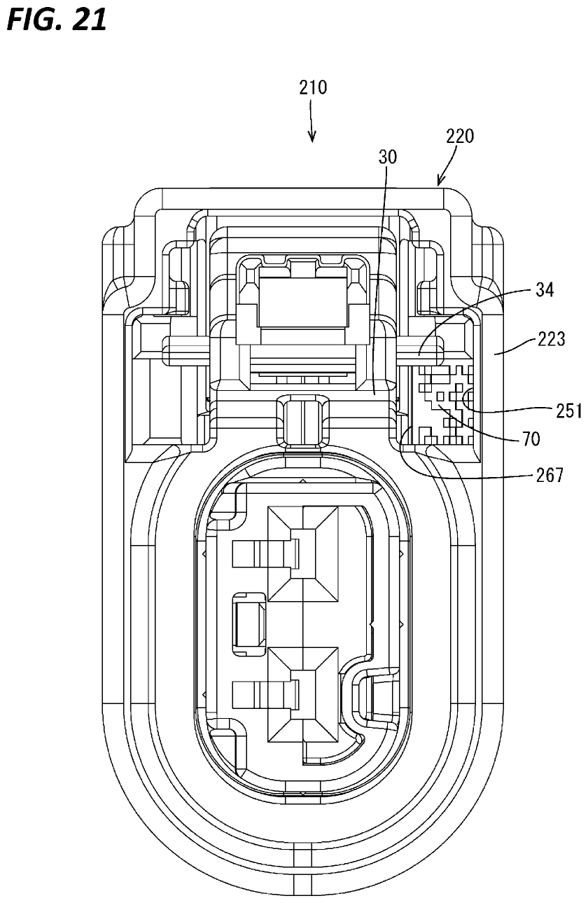

A specific example of a connector 210 of the present disclosure is described with reference to FIGS. 17 to 21. In the following description, the same components as in the first embodiment are not described and components corresponding to those of the first embodiment are denoted by reference signs obtained by adding 200 to numerical parts of the reference signs.

In the second embodiment, the placement of the code 70 is different from that of the first embodiment and, accordingly, the shapes of the CPA member 60 and the housing 20 are partially changed.

A CPA member 260 of the second embodiment includes a push-in portion 261, a CPA body 262 extending from a center of the push-in portion 261 and a pair of arms 268 extending respectively from both sides of the push-in portion 261 as shown in FIG. 17.

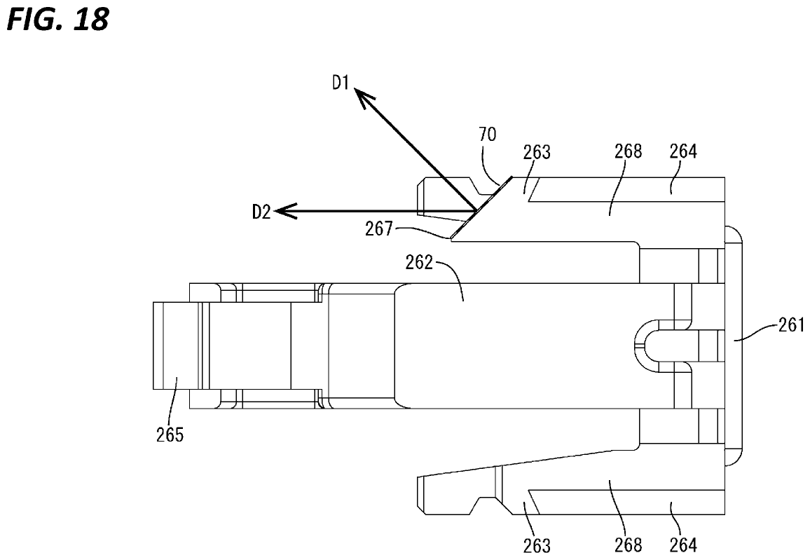

A locking protrusion 263 is provided to project laterally on a side surface of the arm 268 opposite to the CPA body 262. A code placement surface 267 is provided on a front end part of the arm 268. A code 70 is placed on the code placement surface 267. The code placement surface 267 is a flat surface and an inclined surface inclined at an angle of 45° with respect to the front-rear direction, which is a connection direction of the connector 210 and a mating connector 90. The code placement surface 67 of the first embodiment and the code placement surface 267 of the second embodiment are different in that the code placement surface 67 is facing in the direction at 45° to both upward and rearward directions, whereas the code placement surface 267 is facing in the direction at 45° to both forward and lateral directions. The locking protrusion 263 is provided on each of the pair of arms 268 while extending in the vertical direction along the rear edge of the code placement surface 267. As shown in FIG. 18, the arm 268 on a side where the code placement surface 267 is not provided is formed to have a narrower plate thickness toward a front side, whereas the arm 268 on a side where the code placement surface 267 is provided is formed to extend in the front-rear direction while having the same plate thickness.

As shown in FIG. 17, the CPA body 262 includes a CPA base end part 262A extending forward from the push-in portion 261, a CPA intermediate part 262B extending obliquely to an upper front side from the front end of the CPA base end part 262A and a CPA tip part 262C extending forward from the front end of the CPA intermediate part 262B. The CPA intermediate part 62B of the first embodiment and the CPA intermediate part 262B of the second embodiment are different in that the CPA intermediate part 62B has the code placement surface 67, whereas the CPA intermediate part 262B has no code placement surface [ [symbol] 1][LEE2].

Further, the viewing window 51 of the first embodiment and a viewing window 251 of the second embodiment are different in that the viewing window 51 is provided in the push-in portion 61 of the CPA member 60, whereas the viewing window 251 is not provided in the push-in portion 261 of the CPA member 260. The viewing window 251 of the second embodiment is formed between a lock arm 30 and a protection wall 223. Regardless of at which of the start position and the completion position the CPA member 260 is assembled, an operator can view the code 70 through the viewing window 251 from a second direction (direction denoted by D2 in FIG. 18).

However, regardless of at which of the start position and the completion position the CPA member 260 is assembled, a reader cannot detect the code 70 through the viewing window 251 from the second direction D2. Reasons why the reader cannot detect the code 70 include that an excessive deflection restricting piece 34 is arranged in front of the code 70 and the code 70 cannot be read since the reader is easily focused on the excessive deflection restricting piece 34 and is not focused on the code 70.

Besides the above method, a method for disabling the reader to be focused on the code 70 by making an outer receptacle 222 long in the front-rear direction to extend a distance from the reader to the code 70, a method for disabling the reader to be simultaneously focused on parts in front of and behind the code 70 by making an angle of inclination of the code 70 larger than 45° and the like can be cited as a method for disabling the reader to detect the code 70.

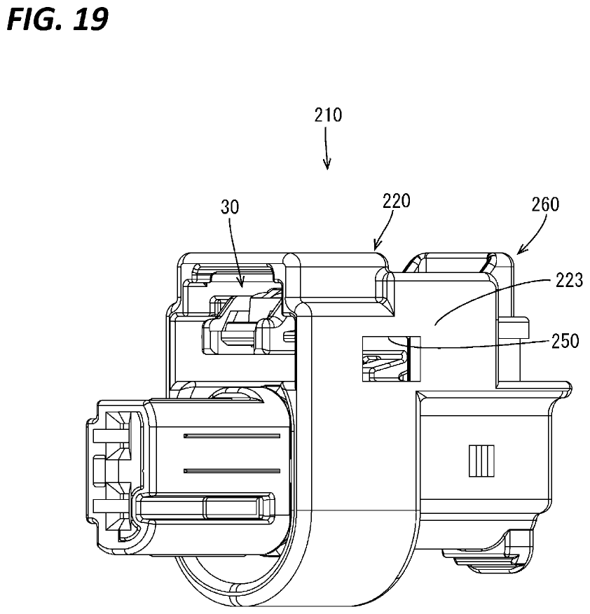

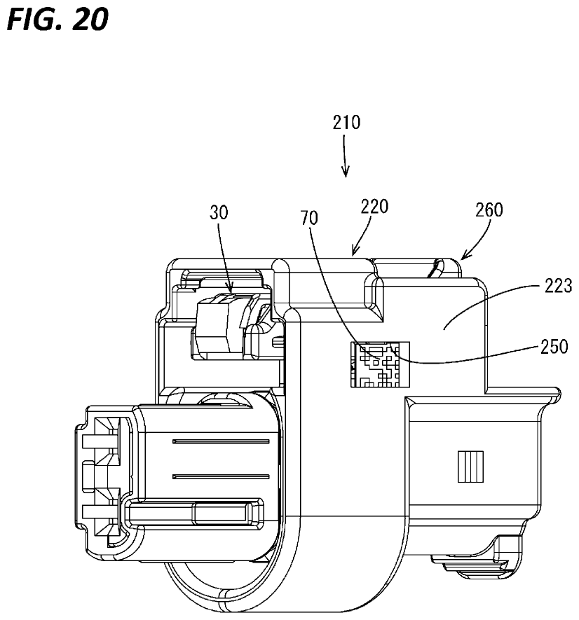

A detection window 250 of the second embodiment is provided through the protection wall 223 in a first direction (direction denoted by D1 in FIG. 18). As shown in FIG. 20, since the code 70 is exposed to outside through the detection window 250 with the CPA member 260 assembled at the completion position, the reader can detect the code 70 from the first direction D1. A direction orthogonal to the plane of FIG. 20 corresponds to the first direction D1 described above. On the other hand, with the CPA member 260 assembled at the start position as shown in FIG. 19, the reader cannot detect the code 70 since the code 70 is arranged behind the detection window 250 and hidden by the protection wall 223.

### Functions and Effects of Second Embodiment

Preferably, a housing 220 is provided with the lock arm 30 for locking the housing 220 in a state connected to the mating housing 91 and a pair of the protection walls 223 disposed on both sides of the lock arm 30, the detection window 250 is provided through a part of the protection wall 223 in the first direction D1 and the viewing window 251 is provided between the lock arm 30 and the protection wall 223 when viewed from the second direction D2.

Since the pair of protection walls 223 are generally provided on the both sides of the lock arm 30, the detection window 250 and the viewing window 251 can be provided, using existing structures such as the lock arm 30 and the protection wall 223.

### Other Embodiments

(1) Although the CPA member 60, 260 is used as an assembly component in the first and second embodiments, a retainer for secondarily locking the female terminals together with the locking lances may be used as an assembly component.

(2) The first and second directions may be other directions without being limited to the directions disclosed in the first and second embodiments. For example, the first direction may be a direction orthogonal to the connection direction.

(3) Although the assembly component is illustrated to be movable between the start position and the completion position in the first and second embodiments, the assembly component may be assembled at the completion position after being once removed from the start position after the connection completion.

(4) Although the housing 20, 220 provided with the lock arm 30 is illustrated in the first and second embodiments, the connector may be a lever-type connector provided with a lever instead of the lock arm. In the case of the lever-type connector, the lever may be an assembly component.

(5) Although detection through the viewing window 251 from the second direction D2 by the reader is not possible in the second embodiment, this detection may be possible.

(6) Although the reader is illustrated as the detecting device in the first and second embodiments, a camera may be used as the detecting device. In that case, the code may be imaged using the camera and may be read by processing the captured image of the code.

### LIST OF REFERENCE NUMERALS

10, 210: connector
20, 220: housing, 21: terminal accommodating portion, 21A: upper surface, 21B: locking lance, 22: outer receptacle, 22A: bulging portion, 22B: back wall, 22C: recess, 23, 223: protection wall, 23A: facing surface, 23B: holding protrusion, 23C: narrow portion, 23D: excessive deflection restricting protrusion, 24: female terminal, 25: side rib
30: lock arm, 31: lock base portion, 32: lock body, 32A: bottom wall, 32B: side wall, 33: locking portion, 33A: tapered surface, 34: excessive deflection restricting piece, 35: operating portion, 36: CPA introducing portion
40: front holder
50, 250: detection window, 51, 251: viewing window
60, 260: CPA member (assembly component, connection assurance member), 61, 261: push-in portion, 62, 262: CPA body, 62A: CPA base end part, 62B: CPA intermediate part, 62C: CPA tip part, 63, 263: locking protrusion, 64, 264: guide rib, 65, 265: restricting projection, 66, 266: reinforcing wall, 67, 267: code placement surface, 68, 268: arm
70: code
90: mating connector, 91: mating housing, 92: inner receptacle, 92A: peripheral wall, 92B: back wall, 93: lock protrusion, 94: male terminal

D1: first direction, D2: second direction, D3: connection direction

1. A connector, comprising:
a housing connectable to a mating housing;
an assembly component having a code placement surface, the assembly component being assembled with the housing at a start position and a completion position; and
a code to be placed on the code placement surface,
the housing including a detection window open in a first direction and a viewing window open in a second direction different from the first direction,
the code being undetectable through the detection window from the first direction by a detecting device and viewable through the viewing window from the second direction with the assembly component assembled at the start position, and
the code being detectable through the detection window from the first direction by the detecting device and viewable through the viewing window from the second direction with the assembly component assembled at the completion position.

2. The connector of claim 1, wherein:
the assembly component is assembled with the housing movably between the start position and the completion position, and
a transition is made from a state where the code is unviewable through the detection window from the first direction to a state where the code is viewable as the assembly component is moved from the start position to the completion position.

3. The connector of claim 2, wherein the assembly component is a connection assurance member, the connection assurance member being immovable from the start position to the completion position before connection of the mating housing and the housing is completed and assuring a connection completed state by being movable from the start position to the completion position after the connection of the mating housing and the housing is completed.

4. The connector of claim 1, wherein the code placement surface is an inclined surface inclined with respect to a connection direction of the mating housing and the housing such that the code is viewable through the detection window from the first direction and viewable through the viewing window from the second direction when the assembly component is assembled at the completion position.

5. The connector of claim 1, wherein:
the housing includes a lock arm for locking the housing in a state connected to the mating housing, and
the detection window is provided through a part of the lock arm in the first direction and the viewing window is provided through a part of the assembly component in the second direction.

6. The connector of claim 5, wherein the code is detectable through the viewing window from the second direction by the detecting device.

7. The connector of claim 1, wherein:
the housing includes a lock arm for locking the housing in a state connected to the mating housing and a pair of protection walls disposed on both sides of the lock arm, and
the detection window is provided through a part of the protection wall in the first direction and the viewing window is provided between the lock arm and the protection wall when viewed from the second direction.
